(19) United States
(12) Patent Application Publication
(10) Pub. No.: US 2007/0237356 A1
(43) Pub. Date: Oct. 11, 2007

(54) Parcel imaging system and method

(76) Inventors: John Dwinell, Wrentham, MA (US); Long Xiang Bian, Sharon, MA (US)

Correspondence Address: Iandiorio & Teska, 260 Bear Hill Road, Waltham, MA, 02451-1018, US

(21) Appl. No.: 11/732,546

(22) Filed: Apr. 4, 2007

Related U.S. Application Data
(60) Provisional application No. 60/790,375, filed on Apr. 7, 2006.

(51) Int. Cl. G06K 9/00

(52) U.S. Cl. 382/101

(57) ABSTRACT

A parcel imaging system includes means for transporting parcels and image sensors oriented to image the parcels. An image construction subsystem is configured to stitch together outputs of the image sensors to produce at least one two-dimensional images of a parcel, and to construct, using the at least one two-dimensional image, at least one displayable three-dimensional image of the parcel.

### RELATED APPLICATIONS

This application claims the benefit of and priority to U.S. Provisional Patent Application Ser. No. 60/790,375 filed Apr. 7, 2006, which is incorporated herein by reference.

### FIELD OF THE INVENTION

The subject invention relates primarily to parcel shipping and sorting systems.

### BACKGROUND OF THE INVENTION

In a modern parcel shipping and/or sorting installation, parcels proceed on a conveyor belt or other transport means (e.g., tilt trays) through a tunnel and an overhead dimensioning system determines the height, width and length of the individual parcels. Various dimensioning systems are based on different technologies. There are laser ranging systems, scanning systems, triangulated CCD camera/laser diode systems such as the DM-3000 Dimensioner (Accu-Sort), and LED emitter-receiver systems.

On the tunnel downstream of the dimensioning system is typically a bar code decoder system. Again, various technologies are available including laser scanners and imagers such as the SICK IDP series of cameras. Sometimes, the dimensioning system provides an output to the bar code decoder system to focus it on the parcel. Bar code information for each parcel is stored in a computer which may be a node in a networked system.

When line scan cameras are used in the bar code decoder system, the one-dimensional scans of the parcel as it moves past the cameras are stitched together to form a two-dimensional image so any bar code in the two-dimensional image can be decoded.

Three-dimensional images of the parcels are not created. Thus, there is really no record of the complete parcel which can be used to identify the parcel or to establish its condition at a particular shipping and/or sorting installation.

Sometimes, a parcel is damaged somewhere in transmit but there is often no hard evidence where the damage occurred. Other times, a person who ships a parcel will not provide adequate postage based on the correct or legal for trade dimensions of the parcel as determined by the dimensioning system. The dimensioning system of the parcel shipping and/or sorting installation will record the dimensions of the parcel but associating those dimensions with a three-dimensional image of the parcel is not currently possible.

Also, fraud is a concern in the parcel shipping industry. In one example, a parcel (e.g., an expensive computer or television) includes a shipping label indicating the parcel is to be shipped to one destination. When the parcel arrives at a shipping/sorting installation, a worker places a different shipping label over the original shipping label. The new shipping label indicates the parcel is to be shipped to a different location—often the worker's address or the address of a co-conspirator of the worker. Detecting and/or preventing such fraudulent actions are difficult.

### SUMMARY OF THE INVENTION

It is therefore an object of this invention to provide a system for and method of identifying parcels as they are processed at shipping/sorting installations.

It is a further object of this invention to provide such a system and method which can be used to establish the condition of parcel as it is processed at various shipping/sorting installations.

It is a further object of this invention to provide such a system and method which can be used to establish dimensions of parcels as they are processed at shipping/sorting installations.

It is a further object of this invention to provide such a system and method which can be used to detect and/or prevent fraud.

The subject invention results from the realization that if a three-dimensional image of a parcel is created as it is processed at a shipping/sorting installation, typically by stitching together the outputs of the bar code decoder system line scan cameras to provide two-dimensional images of the parcel and then constructing three-dimensional images of the parcel from the two-dimensional images, then parcels can be more easily and ergonomically identified, the condition of the parcel at that installation can be established, the dimensions of the parcel can be more easily associated with the parcel, and fraud can be detected and/or prevented.

The subject invention, however, in other embodiments, need not achieve all these objectives and the claims hereof should not be limited to structures or methods capable of achieving these objectives.

This invention features a parcel imaging system including means for transporting parcels and image sensors oriented to image the parcels. An image construction subsystem is configured to stitch together outputs of the image sensors to produce at least one two-dimensional image of a parcel, and construct, using the at least one two-dimensional image, at least one displayable three-dimensional image of the parcel. In one example, the image sensors are line scan cameras.

In one embodiment, the image construction subsystem is configured to construct at least one displayable three-dimensional image of the parcel using at least two two-dimensional images of the parcel. In another embodiment, the system further includes a general dimension subsystem including parcel dimension information, and the image construction subsystem is configured to construct at least one displayable three-dimensional image of the parcel using one two-dimensional image of the parcel and at least one parcel dimension. The three-dimensional image of the parcel may not include any background image.

In one variation, the system includes a background stripper subsystem configured to strip any background image from the at least one two-dimensional image using a combination of image contrast information and parcel dimension information. In one configuration, the background stripper subsystem is configured to determine pixel coordinates of a corner of the parcel in the least one two-dimensional image using the parcel dimension information, conduct line scans proximate the corner, calculate an average numerical value of the pixels in each line scan, detect a significant change in the average numerical value of the pixels of the line scans proximate the pixel coordinates of the corner, and set the pixel coordinates of the corner to pixel coordinate values where the significant change in the average numerical value of the pixels of the line scans was detected. The background stripper subsystem may be further configured to conduct multi-level detection and set the pixel coordinates of the corner using sub-sampling of the two-dimensional image. In one example, the background stripper subsystem is configured to set the pixel coordinates of four corners of the parcel in the at least one two-dimensional image, and to strip any background image outside of the set pixel coordinates and the dimensions of the two-dimensional image of the parcel.

In another configuration the background stripper subsystem is configured to determine pixel coordinates of a point on the parcel in the least one two-dimensional image using the parcel dimension information, conduct line scans proximate the point, calculate an average numerical value of the pixels in each line scan, detect a significant change in the average numerical value of the pixels of the line scans proximate the pixel coordinates of said point, and set the pixel coordinates of said point to pixel coordinate values where the significant change in the average numerical value of the pixels of the line scans was detected. The parcel dimension information may be general parcel dimension information. The background stripper subsystem may be further configured to locate a plurality of points on the two-dimensional image of the parcel and create a mapping of the points. Using the mapping, at least one line may be formulated representing at least one edge of the parcel in the two-dimensional image. The background stripper subsystem may be further configured to formulate lines representing each edge of the parcel in the two-dimensional image.

The image construction subsystem may be configured to construct the at least one displayable three-dimensional image from stripped two-dimensional images, and to construct the at least one displayable three-dimensional image by fitting the stripped two-dimensional images into a three-dimensional frame. The two-dimensional images may be less than full resolution, and the image construction subsystem may be configured to sample each two dimensional image and/or to compress each two-dimensional image. The image construction subsystem also may be configured to display any view of the three-dimensional image of the parcel. The system also typically further includes a rotation module configured to rotate a displayed three-dimensional image of the parcel.

In one variation, the system includes a brightness adjustment module configured to adjust the brightness of the three-dimensional image of the parcel, and the brightness adjustment module may also be configured to normalize the brightness of each visible face of the three-dimensional image of the parcel as well as adjust the normalized brightness depending on the orientation of the parcel. In one example the brightness adjustment module is configured to normalize the brightness of each visible face of the three-dimensional image of the parcel by generating a histogram of a visible face of three-dimensional image of the parcel, and from the histogram, determining the maximum of the histogram of the visible face. The brightness adjust module is also configured to determine the maximum of a gray level of the visible face using the histogram, calculate the size of the visible face using parcel dimension information, set maximum brightness of the visible face at a predetermined value, generate an interrelationship between the maximum of the histogram, the maximum of the gray level, and the size of the visible face, plot a correlation curve based on the interrelationship, and interpolate a normalized output image using the correlation curve.

Also, the brightness adjustment module may be configured to adjust the normalized brightness by detecting a normal vector for a visible face of the three-dimensional image of the parcel, determining a z-vector value for the normal vector detected, and multiplying the z-vector value by the normalized brightness of the visible face. A dimensioning module may be configured to display the dimensions of the parcel with the three-dimensional image of the parcel. The image construction subsystem may also be configured to store the three-dimensional image of the parcel in a file, and the file may further include data concerning said parcel. The data may include bar code data and/or parcel dimension data.

This invention also features a parcel imaging method including transporting parcels, imaging the parcels with image sensors, stitching together outputs of the image sensors to produce at least one two-dimensional image of a parcel, and constructing, using the at least one two-dimensional image, at least one displayable three-dimensional image of the parcel. In one example, the image sensors are line scan cameras.

In one embodiment, constructing at least one displayable three-dimensional image of the parcel includes using at least two two-dimensional images of the parcel. In another embodiment, a general dimension subsystem includes parcel dimension information, and constructing at least one displayable three-dimensional image of the parcel includes using one two-dimensional image of the parcel and at least one parcel dimension. The three-dimensional image of the parcel may not include any background image. In one variation, the background image is stripped from the two-dimensional image using a combination of image contrast information and parcel dimension information.

In one configuration the background image is stripped from the two-dimensional image by determining pixel coordinates of a corner of the parcel in the least one two-dimensional image using the parcel dimension information, conducting line scans proximate the corner, calculating an average numerical value of the pixels in each line scan, detecting a significant change in the average numerical value of the pixels of the line scans proximate the pixel coordinates of the corner, and setting the pixel coordinates of the corner to pixel coordinate values where the significant change in the average numerical value of the pixels of the line scans was detected. The method may include conducting multi-level detection and setting the pixel coordinates of the corner using sub-sampling of the two-dimensional image. In one example, the pixel coordinates of four corners of the parcel are set in the at least one two-dimensional image. Any background image outside of the set pixel coordinates and the dimensions of the two-dimensional image of the parcel may be stripped.

In another example, the background stripper subsystem may be configured to determine pixel coordinates of a point on the parcel in the least one two-dimensional image using the parcel dimension information, conduct line scans proximate the point, calculate an average numerical value of the pixels in each line scan, detect a significant change in the average numerical value of the pixels of the line scans proximate the pixel coordinates of said point, and set the pixel coordinates of said point to pixel coordinate values where the significant change in the average numerical value of the pixels of the line scans was detected. The parcel dimension information may be general parcel dimension information. The background stripper subsystem may be further configured to locate a plurality of points on the two-dimensional image of the parcel, create a mapping of said points, and from the mapping formulate at least one line representing at least one edge of the parcel in the two-dimensional image. The background stripper subsystem may be further configured to formulate lines representing each edge of the parcel in the two-dimensional image. The at least one displayable three-dimensional image may be constructed from stripped two-dimensional images, which may be constructed by fitting the stripped two-dimensional images into a three-dimensional frame. The two-dimensional images may be less than full resolution, and each two-dimensional image may be sampled and/or compressed.

The method may further include displaying any view of the three-dimensional image of the parcel, including rotating a displayed three-dimensional image of the parcel, and may include adjusting the brightness of the three-dimensional image of the parcel. In one example, adjusting the brightness includes normalizing the brightness of each visible face of the three-dimensional image of the parcel and adjusting the normalized brightness depending on the orientation of the parcel. In one configuration, normalizing the brightness includes generating a histogram of a visible face of three-dimensional image of the parcel, and from the histogram, determining the maximum of the histogram of the visible face. Normalizing the brightness further includes determining the maximum of a gray level of the visible face using the histogram, calculating the size of the visible face using parcel dimension information, setting maximum brightness of the visible face at a predetermined value, generating an interrelationship between the maximum of the histogram, the maximum of the gray level, and the size of the visible face, plotting a correlation curve based on the interrelationship, and interpolating a normalized output image using the correlation curve. Also, adjusting the normalized brightness may include detecting a normal vector for a visible face of the three-dimensional image of the parcel, determining a z-vector value for the normal vector detected, and multiplying the z-vector value by the normalized brightness of the visible face.

The method may further include displaying with the three-dimensional image of the parcel the dimensions of the parcel, and/or storing the three-dimensional image of the parcel in a file. The file may include data concerning said parcel, which may include bar code data and/or parcel dimension data.

This invention further features a parcel shipping method including moving parcels through a tunnel at a primary shipping installation to determine the dimensions of the parcels and to decode bar code information present on the parcels, imaging each parcel to store at least one displayable three-dimensional image of the parcel, and associating the bar code information and/or dimensions of the parcel with the three-dimensional image to identify the parcel; and/or establish the condition of the parcel at the shipping installation; and/or establish the dimensions of the parcel; and/or to detect; and/or prevent fraud. In one example, imaging each parcel to store at least one displayable three-dimensional image of the parcel includes imaging shipping labels on the parcel. The method may further include imaging each parcel at a second shipping installation to store at least one displayable three-dimensional image of the parcel at the second shipping installation, and typically includes imaging shipping labels on the parcel at the second installation. In one configuration, the method further includes generating an alert signal if the parcel fails to arrive at a destination in accordance with the shipping labels imaged at the primary shipping installation, and may include conducting a search for the parcel. The method may also include generating an alarm signal if the destination in accordance with the shipping labels imaged at the second shipping installation is not the destination in accordance with the shipping labels imaged at the primary shipping installation.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic three-dimensional perspective view showing a typical parcel shipping and sorting installation tunnel;

FIG. 2A is a schematic view of a three-dimensional image displayed on the computer shown in FIG. 1 in accordance with the system and method of the subject invention;

FIG. 2B is a view similar to FIG. 2A showing the three-dimensional image of the parcel has been rotated;

FIG. 3 is a schematic block diagram showing the primary components associated with one example of a parcel imaging system and method in accordance with this invention;

FIG. 4 is a flowchart depicting the primary steps associated with one example of stitching together one-dimensional images in accordance with the present invention;

FIG. 5 is a depiction of one example of an image of the top of a parcel captured by the imaging subsystem shown in FIG. 3;

FIG. 6 is a depiction of one example of an image of the front and side of a parcel captured by the imaging subsystem shown in FIG. 3;

FIG. 7 is a flowchart depicting the primary processing steps of one embodiment of the one-dimensional image stitching module for stitching together one-dimensional images to form two-dimensional images in accordance with the present invention;

FIGS. 8A and 8B are highly schematic depictions of one example of background stripping by a background stripping module in accordance with the present invention;

FIG. 9A is a flowchart depicting the primary processing steps of one embodiment of the background stripper subsystem or module for stripping background imagery from the two-dimensional images in accordance with the present invention;

FIGS. 9B-9D are highly schematic depictions of another example of background stripping by the background stripping module in accordance with the present invention;

FIGS. 10A-10C and 11A-11D are schematic representations of one example showing the steps for constructing a three-dimensional image from two-dimensional images;

FIG. 12 is a flowchart depicting the primary processing steps associated with one embodiment of a three-dimensional image construction module for constructing a three-dimensional image from at least one two-dimensional image in accordance with the present invention;

FIG. 13A is a flowchart depicting the primary processing steps associated with one embodiment of a brightness adjustment module or subsystem for adjusting the brightness of an image in accordance with the present invention;

FIG. 13B is one example of a plot of input image and output image for normalization of an input image in accordance with the present invention;

FIG. 13C is a flowchart depicting the primary steps of one example of a configuration of a brightness adjustment module and associated method in accordance with the present invention;

FIG. 13D is a schematic three-dimensional view of a parcel with three visible faces;

FIG. 14 is a flowchart depicting the primary steps associated with the parcel shipping method in accordance with the present invention;

FIGS. 15A and 15B are schematic perspective views of displayed three-dimensional images which provide one example of fraud detection in accordance with the present invention; and

FIG. 16 is a flowchart depicting the primary steps of one example of a parcel shipping method in accordance with the present invention.

### DETAILED DESCRIPTION OF THE INVENTION

Aside from the embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

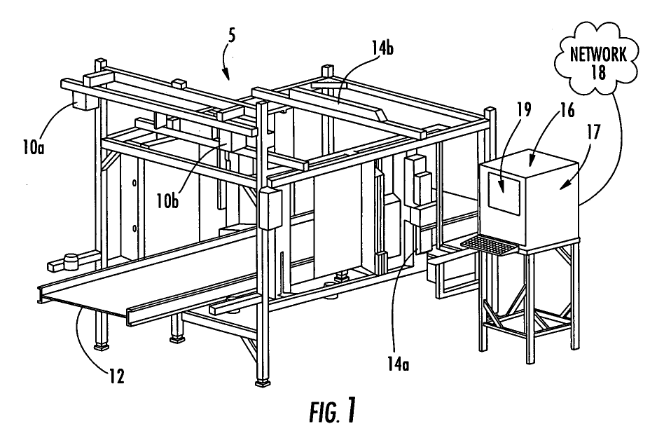

FIG. 1 depicts a parcel shipping/sorting system tunnel typically used at a carrier installation such as a UPS or FedEx installation. Camera tunnel 5 includes a parcel dimensioning system with one or more units 10a, 10b, and the like configured to measure the dimensions and position of a parcel traveling on parcel transport conveyor 12. Tilt trays and other transport means are known in the art. Various parcel dimensioning technologies are currently in use as explained in the Background section above, and one dimensioning system for determining more accurate dimensions is more fully described in the co-pending U.S. patent application filed on even date herewith entitled Parcel Dimensioning Measurement System and Method, by common inventors as those hereof and the same assignee, which is incorporated herein by reference.

A bar code decoding system would typically include one or more additional downstream units, 14a, 14b, and the like, in order to decode any bar code present on the parcel. Again, various technologies are currently in use including those discussed in the Background section above. Typically, units 14a, 14b, and the like are auto focus line scan cameras. These cameras may be placed about the camera tunnel to image the top, the sides, and/or the bottom of the parcels, i.e. each face of the parcel. Sometimes, the output of the dimensioning system is also provided as an input to the bar code decoder camera unit(s) to focus the same.

Computer rack 16 is linked to both the dimensioning and barcode decoder systems to process the outputs of each system and keep a record of the data collected concerning each parcel on conveyor 12. Computer 17 with monitor 19 may be a node in network 18 so numerous shipping/sorting systems can be linked together to share records.

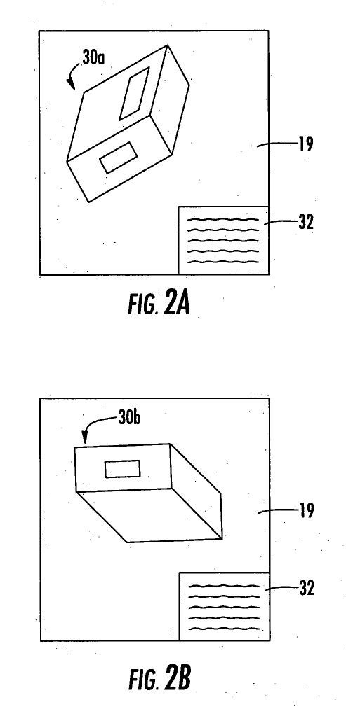

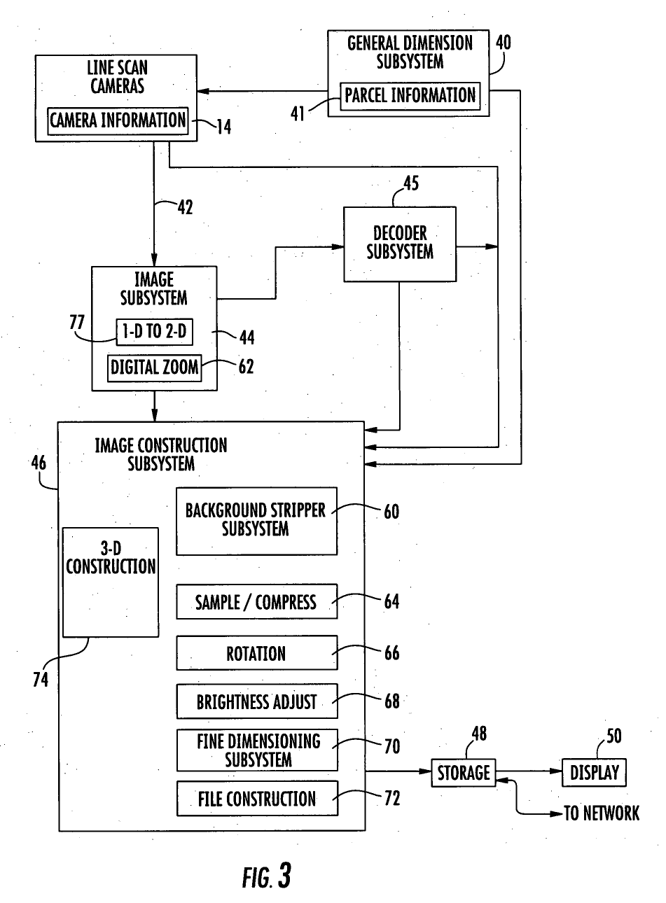

In accordance with this subject invention, the outputs of line scan cameras 14a, 14b, and the like are used not just to decode the bar codes present on the parcels but also to construct and record three-dimensional images of the parcels displayable, for example, on computer monitor 19 as shown in FIG. 2A. The three-dimensional image 30a of a parcel may be rotated as shown at 30b in FIG. 2B and otherwise manipulated in accordance with this invention, and also may be stored in a file along with bar code information and/or the parcel dimension information as shown at 32 to more easily and ergonomically identify a given parcel. The three-dimensional image of the parcel also assists in establishing the condition of the parcel at the shipping installation, assists in establishing the dimensions of the parcel, and/or can be used to detect and/or prevent fraud.

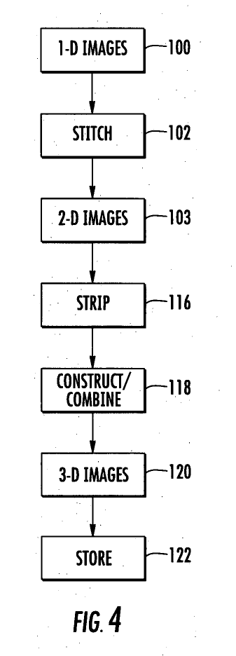

An exemplary system is shown in FIG. 3. Typically, the output from a typical general dimension subsystem 40 (including unit 10a, 10b, and the like, FIG. 1) provides general position and rough or general dimension data to image sensors such as line scan cameras 14 which then controls their focusing on the various parcels.

An analog-to-digital converter measures the charge on each pixel of the line scan cameras and converts the charge information to a digital output provided on fiber optic cable 42 as an input to the imaging subsystem software 44 which then stores the image or images in a memory. A CMOS sensor could also be used. There may be one image sensor and associated optical elements provided and oriented to image all three dimensions of a parcel or multiple image sensors oriented to view different parcel dimensions, e.g., the top, the bottom, and one or more sides. In one embodiment there are at least two line scan cameras oriented to image the parcels.

Using the image or images in memory, bar code decoder subsystem 45 decodes any barcodes present on the parcel. See U.S. Pat. No. 6,845,914 and co-pending application Ser. No. 10/382,405 (U.S. Pat. App. Publ. No. 2004/0175052) both incorporated herein by this reference.

The output of imaging subsystem 44, in accordance with this invention, is also provided to image construction subsystem 46 configured, as discussed above, to produce a viewable three-dimensional image of each parcel passing through the tunnel of a shipping/sorting installation. The outputs of general dimension subsystem 40 and bar code decoder system 45 can also be routed to image construction subsystem 46, as shown, to associate, with each three-dimensional parcel image, the general parcel dimension and bar code(s) information. General dimension subsystem 40 typically includes parcel information 41 for locating the general area of the parcel in the image, such as rough or general information regarding parcel length, width and height, as well as its angle on the transport conveyor, its center of gravity, and its four corner coordinates, although the invention is not so limited, and general dimension subsystem 40 may include more or less types of information for a particular application. Parcel information 41 may be stored separately in general dimension subsystem 40 for use whenever needed for a particular application, such as for image reconstruction in accordance with the subject invention.

Image sensors or line scan cameras 14, such as auto focus line scan CCD cameras, provide camera information 43 to imaging subsystem 44 and/or image construction subsystem 46. Camera information 43 includes information concerning the actual physical layout of the camera tunnel through which the parcel passes, and typically includes information such as the number of cameras, which camera is providing the information and from what angle (i.e. top camera at 15°, side camera at 45°) as well as information regarding DPI (dots per inch) and LPI (lines per inch). An operator can set some particular parameters for the camera tunnel configuration, i.e. camera angles, which may be verified by the system with a test box or parcel.

Image construction subsystem 46 can display and store three-dimensional parcel images, and/or the output of image construction subsystem 46, including but not limited to three-dimensional parcel images, can be stored as shown at 48 and displayed as shown at 50 (see also FIGS. 2A-2B). Storage 48 including files containing e.g. three-dimensional images of each parcel so processed along with bar code and/or dimensional data can be accessed via a network as shown and as discussed above with reference to FIG. 1.

A preferred image construction subsystem 46 includes software or makes use of various technology to, for example, strip the background image from the parcel so only the parcel itself is displayed. Thus, background stripper subsystem or module 60 may be a component of image construction subsystem 46. A digital zoom module 62 in the imaging subsystem 44 can be used to keep uniform DPI and LPI for any part in the parcel. To the extent that digital zoom is provided in a camera itself, it can be corrected by digital zoom module 62 as necessary. The two-dimensional parcel images are discussed more fully below.

Sampling/compression module 64 can be used to reduce the file size of a three-dimensional image and/or to retain, as high resolution data, only selected portions of a parcel (e.g., labels and the like). Rotation module or subsystem 66 allows the user to rotate a displayed three-dimensional parcel image as shown in FIGS. 2A-2B. Brightness adjustment module or subsystem 68 provides a more realistic looking three-dimensional parcel image especially as it is rotated. Fine dimensioning subsystem or module 70 allows the user to more accurately measure the dimensions of a parcel and/or display its three-dimensional image using the output of general dimension subsystem 40. In one variation, file construction module 72 associates and stores the three-dimensional image of a parcel with, for example, its bar code and/or dimension data in a single file for later retrieval. Three-dimensional image construction module 74 constructs displayable three-dimensional images from two or more two-dimensional images. Preferably, subsystems or modules 60-74 are software modules configured or programmed to perform their various functions.

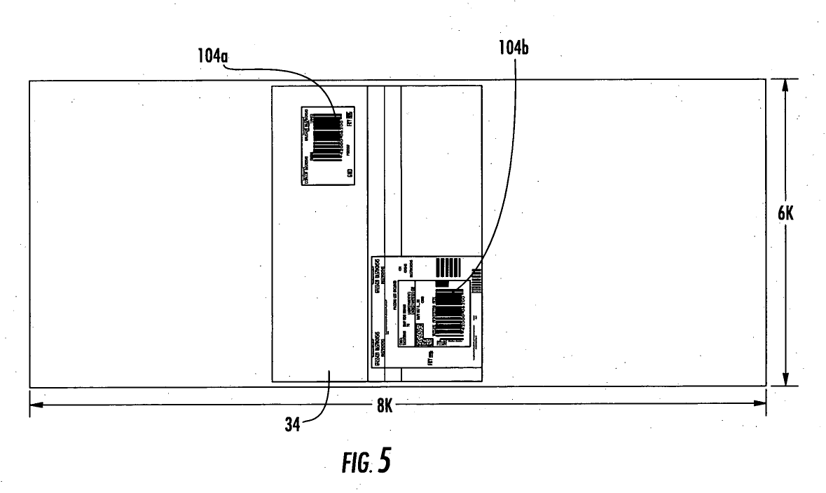

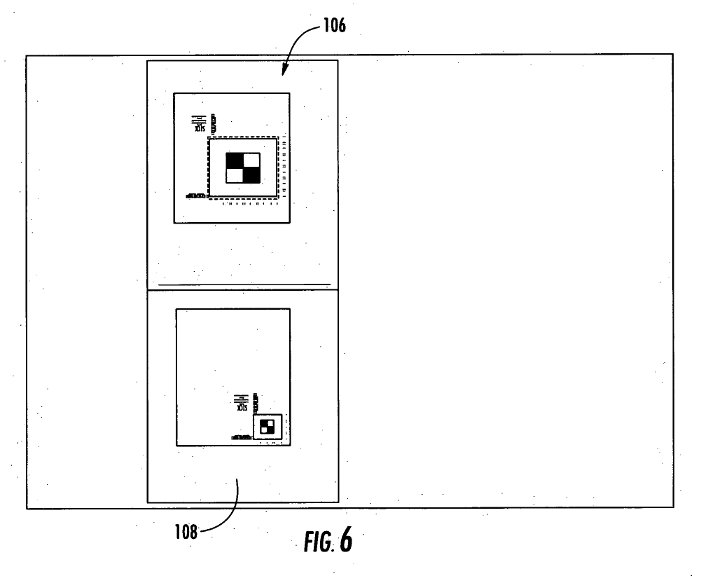

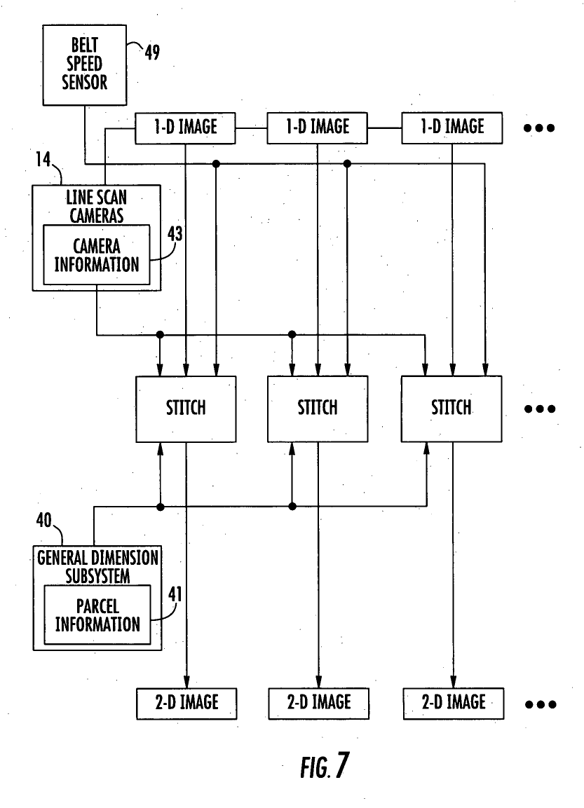

According to one preferred parcel imaging method, the line scan cameras provide multiple one-dimensional images of a portion of a parcel, step 100, FIG. 4. These one-dimensional images are stitched together, step 102 to produce one or more two-dimensional images, step 103. FIG. 5 shows a two-dimensional image of the top of a parcel with bar codes 104a and 104b. This image was produced by stitching together one-dimensional images output from a line scan camera oriented above the parcel. FIG. 6 shows a two-dimensional image of side 106 and front 108 of the same parcel. This image was produced by stitching together the one-dimensional output from a line scan camera oriented on one side of a parcel in which the parcel was at an angle on the tunnel conveyor. Typically, imaging subsystem 44, FIG. 3 produces these two-dimensional stitched together images. Image construction subsystem 46, FIG. 3 then strips away any background imagery, step 116, FIG. 4. Then, the one or more three-dimensional images are constructed by combining two-dimensional images or at least one two-dimensional image and parcel dimension information (as discussed further below), steps 118-120 and then the images can be stored, step 122.

The parcel imaging systems and methods of the subject invention offer increased effectiveness and improvement over having images created by, for example, digital cameras, because digital camera imaging would be limited by the high speed of the parcels conveyed as well as the positioning of the parcels one behind another.

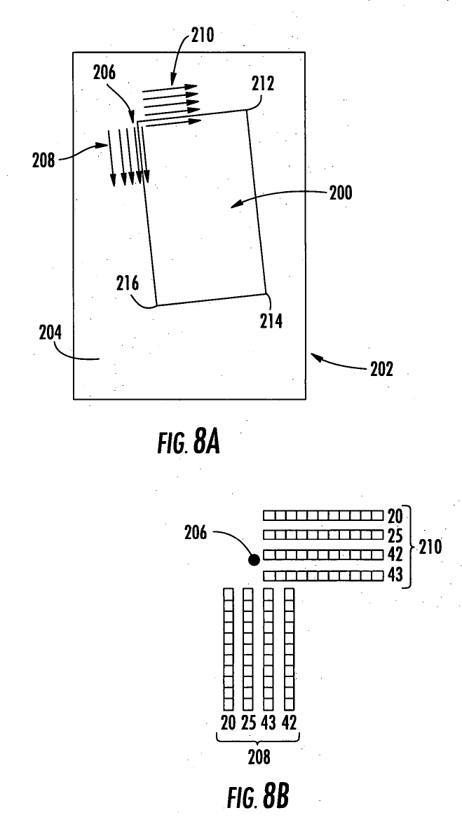

As noted above, cameras or units 14a, 14b such as auto focus line scan CCD cameras, FIG. 1 provide multiple one-dimensional images of a portion of a parcel, which are typically stored in imaging subsystem 44, FIG. 3. In just one example, each one-dimensional image is a 8000 pixel×1 pixel array. Stitching together one-dimensional images to form two-dimensional images is accomplished by one-dimensional image stitching module or subsystem 77 of imaging subsystem 44. Known methods may be used, e.g. software supplied by Omniplanner, or other commercially available software or systems. Preferably, however, constructing two-dimensional images or stitching one-dimensional images together to form two-dimensional images is achieved as shown in FIG. 7, using camera information 43 and information from general dimension subsystem 40. As discussed above, the output of general dimension system 40 can be provided as input to a bar code decoder camera to focus the camera. In stitching together the one-dimensional images to form two-dimensional images, the cameras are also focused, with adjustments made for package position and movement. This focusing is provided for using information from general dimension subsystem 40. Belt speed sensor 49, such as a tachometer in one non-limiting example, senses conveyor belt speed in the camera tunnel such that the number of one-dimensional scans per second, the scanning rate, may be increased or decreased as necessary to accommodate for changes in conveyer belt speed and maintain constant LPI. Proper camera angle settings for scanning the one-dimensional images are provided by camera information 43 from line scan cameras 14. Two-dimensional images are formed by stacking or stitching multiple one-dimensional images using information and data from general dimension subsystem 40, belt speed sensor 49, and camera information 43.

Thus, one or more two-dimensional images which can show the top or sides of a parcel for example, see FIGS. 5 and 6, are produced from one-dimensional mages.

In accordance with the parcel imaging system of the subject invention, the background imagery of selected two-dimensional images is stripped away by background stripper subsystem 60, FIG. 3, which is typically part of image construction subsystem 46. In one example, background stripper subsystem 60 of image construction imaging subsystem 46 is configured to strip away background imagery based on the general parcel dimension information in combination with image contrast information to more accurately strip away background imagery.

When the contrast between the two-dimensional image of the package or parcel and the background is sharp, background can be stripped away using either the parcel dimensions or contrast information. However, even though parcel dimensions may be known, it may be difficult to strip background away from the two-dimensional images when the parcel image and background are barely distinguishable to the naked eye because of poor image quality. In accordance with one aspect of the present invention, contrast is utilized in combination with the parcel dimensions to provide a better outline of the parcel—as compared to background imagery—within the entire image, so background stripper subsystem 60, FIG. 3 can strip away the background more precisely.

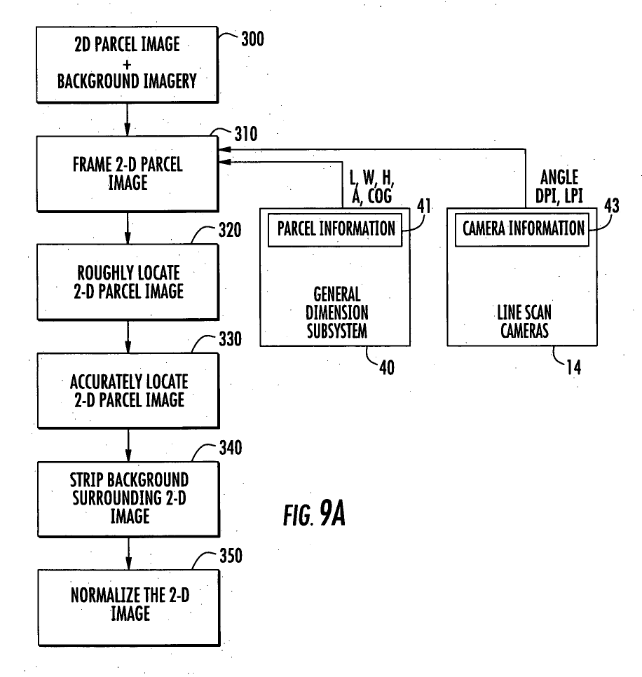

In one embodiment, using the general parcel dimensions obtained from general dimension subsystem 40, i.e. length, width, height, as well as center of gravity and angle on the conveyor belt, and camera information 43 from line scan cameras 14, FIG. 7, i.e. camera angles, DPI and LPI, the pixel coordinates of the corners of the parcel are determined. Thus, the shape and position of the top of the parcel 200, for example, FIG. 8A is roughly located within the entire image 202. Next, contrast is used to more precisely locate the parcel 200 in background 204. It is known in the art that, for example, if a pixel has a numerical value of 255, that pixel is white. If a pixel has a numerical value of 0, it is black. Pixels having values between 0 and 255 represent variations between white and black, i.e. gray scale. When image quality is less than ideal, pixels near corner 206 of parcel 200, for example, have gray scale values which make the corner indistinguishable to the naked eye. Corner 206 can be more precisely determined, however, by conducting line scans 208, 210 proximate corner 206 as located using parcel dimensions. In one example, scans 208 and 210 are conducted along edges of the parcel image proximate corner 206, as located by the general parcel dimensions and/or the image. The parcel dimensions may be from the general dimension subsystem 40, FIG. 3, or from fine dimensioning subsystem 70 as more fully described in the co-pending U.S. patent application filed on even date herewith entitled Parcel Dimensioning Measurement System and Method, by common inventors as those hereof and the same assignee, which is incorporated herein by reference.

The average numerical value of the pixels in each line scan is calculated, and the average value of the pixels in each line scan will change more sharply or significantly near parcel corner 206 at or near the intersection of two line scans as shown in FIG. 8B. When such a change in average value is detected, corner 206 can be set to the pixel coordinate values, e.g. x and y coordinates as discussed more fully below, where the significant change is detected, thus more precisely locating the corner. The location of each corner 206, 212, 214, and 216 of each two-dimensional image of parcel 200 may be determined in this same way as necessary, and this operation may be performed on each two-dimensional image of each face of the parcel, namely not only the top, but also the bottom, front, back, right and left sides of the parcel.

Because it can be desirable to conduct a multi-level search for the corners for even more accuracy, in one embodiment, a sub-sample of the entire image is created first, where every 64^{th} pixel is used to create a 64×64 pixel thumbnail image. The foregoing process is then conducted to determine the corners of the parcel as necessary for low contrast areas by locating corners of one of the six faces of the parcel (i.e. top, bottom, right, left, front or back) within this 64×64 area. Once the corner is located as a point within this 64×64 area, the process is then repeated for a 16×16 area then a 1×1 area, where the latter is the true corner. Once four corners of a two-dimensional image of the parcel are determined, the x and y coordinates for the parcel corners are more precisely known, the dimensions and outline of the parcel are better established, and the background can be stripped away or discarded, leaving only the two-dimensional parcel image. As noted, this process can be repeated for all six faces of the parcel as necessary depending on the contrast in any particular image.

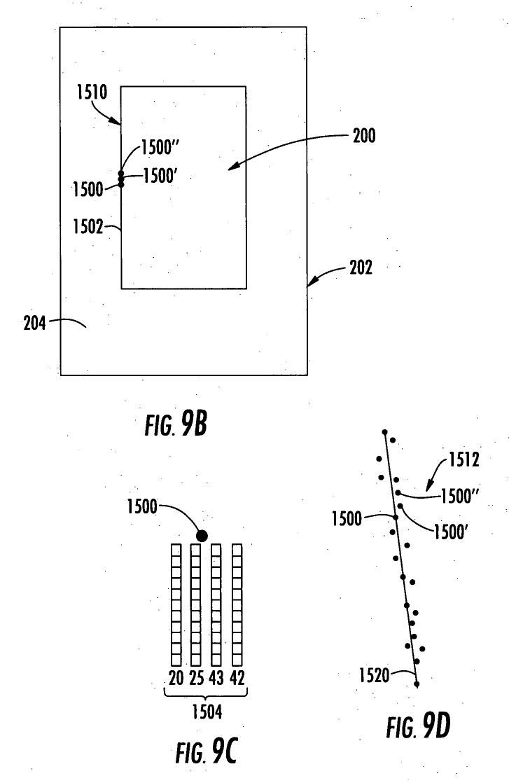

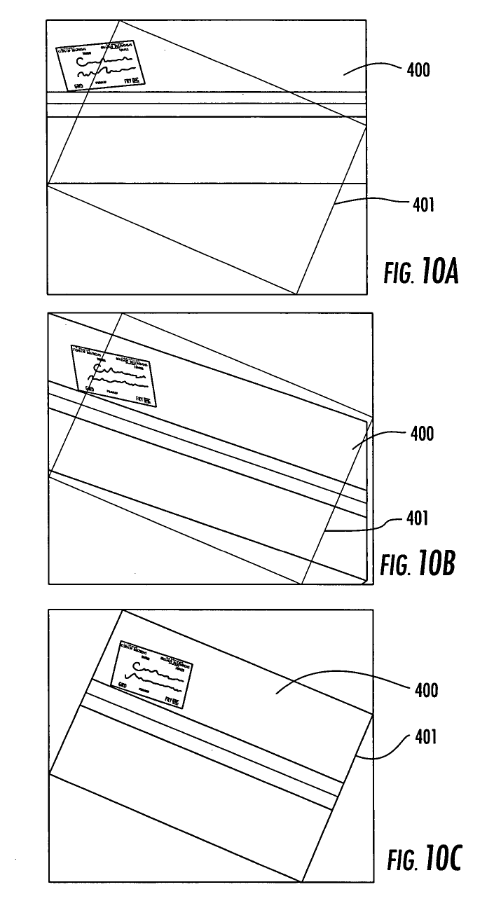

A summary of one example of the operation of background stripper subsystem 60, FIG. 3 is shown in flowchart form in FIG. 9A. From the various line scan cameras in the camera tunnel, two-dimensional parcel image and background imagery is captured, step 300. Utilizing parcel information 41 and camera information 43, a frame of one two-dimensional face of the parcel (i.e. top, bottom, right, left, front or back face) within the background imagery is obtained, step 310, and parcel dimensions, typically from the general dimension subsystem 40, are used to roughly or generally locate this two-dimensional face of the parcel, step 320. This two-dimensional parcel image is then more accurately located, using for example the corner location described above, step 330. In step 340, the background pixels surrounding the two-dimensional image are stripped away or discarded, and this operation is performed for each of the six faces of the parcel as necessary, leaving the two-dimensional parcel images of each of the six faces with no background. Step 350 is an additional optional step where the two-dimensional image is normalized, in one example to 456×456 pixels. In one preferred example, the two-dimensional image is normalized using the spread method as known in the art. Normalization of the two-dimensional image facilitates construction of the three-dimensional image, discussed in more detail below, especially in cases when the dimensions of a particular parcel face are very small, as in the case of a long, thin package.

In another variation, one or more points along the vicinity of an edge of the parcel, other than corners or in addition to corner points, may also be more precisely located and utilized for background stripping. Point 1500, FIG. 9B as well as other points, 1500′, 1500″ and so on, in the vicinity of edge 1502 of parcel 200 may be more precisely determined by conducting line scans 1504, FIG. 9C proximate point 1500, as well as proximate points 1500′, 1500″ and so on all along the vicinity of edge 1510 as located using the general parcel dimensions. By conducting line scans at a plurality of such points a mapping 1512, FIG. 9D of points—which may be indicative of an edge and/or the length, width or height of the parcel—is created based on detection of a change in the average pixel value for each line scan. Edge point 1500, as well as other edge points 1500′, 1500″ can be set to the pixel coordinate values where the significant average value change is detected in order to create mapping 1512 which includes a plurality of such points. An edge of the parcel can thus be more precisely located by formulating a line 1520 more precisely representing a parcel edge using the pixel coordinate values for the mapping than by using only the raw or general dimension values for edge 1520. As noted this is especially valuable when image quality is less than ideal and/or when there is little to no contrast between the parcel and the background. A similar operation may be performed for each edge of the parcel and for each parcel face. A multi-level search for the points similar to that described above may be conducted. Also in similar fashion a line representing each edge of the parcel in each two-dimensional image may be formed, and for each two-dimensional image of each side of the parcel, such that the background may be stripped from any two-dimensional image of the parcel.

After background stripper module 60, FIG. 3 of image construction module 46 strips the background from the two-dimensional images created using output from at least two one-dimensional line scan cameras, the eventual three-dimensional image of the parcel preferably does not include any background imagery, and thus only the image of the parcel itself is displayed.

The three-dimensional images formed in accordance with the present invention are constructed in three-dimensional image construction module 74 using the two-dimensional images which have been stripped away from the background imagery.

Each two-dimensional image of the six faces (top, bottom, left, right, front, back) of the package which has had the background stripped away can be fitted into a three-dimensional frame. The three-dimensional frame can be formed, and can be rotated by movement of a computer mouse, for example, by techniques known in the art. Each of the six two-dimensional faces has a z vector value indicative of the two-dimensional image orientation. When the two-dimensional image (of a face) is directly toward the viewer, the z value will be 1. If the two-dimensional image is away from the viewer such that it cannot be seen, the z value will be less than zero, and the z value will be zero if the particular face is perpendicular to the viewer. From the z value then, orientation of the particular two-dimensional image of a face of the parcel is known. If the two-dimensional image has been normalized, for example according to the option discussed above and described in more detail below, a scaling algorithm may be used to restore the image to its original size for proper fitting within the three-dimensional frame.

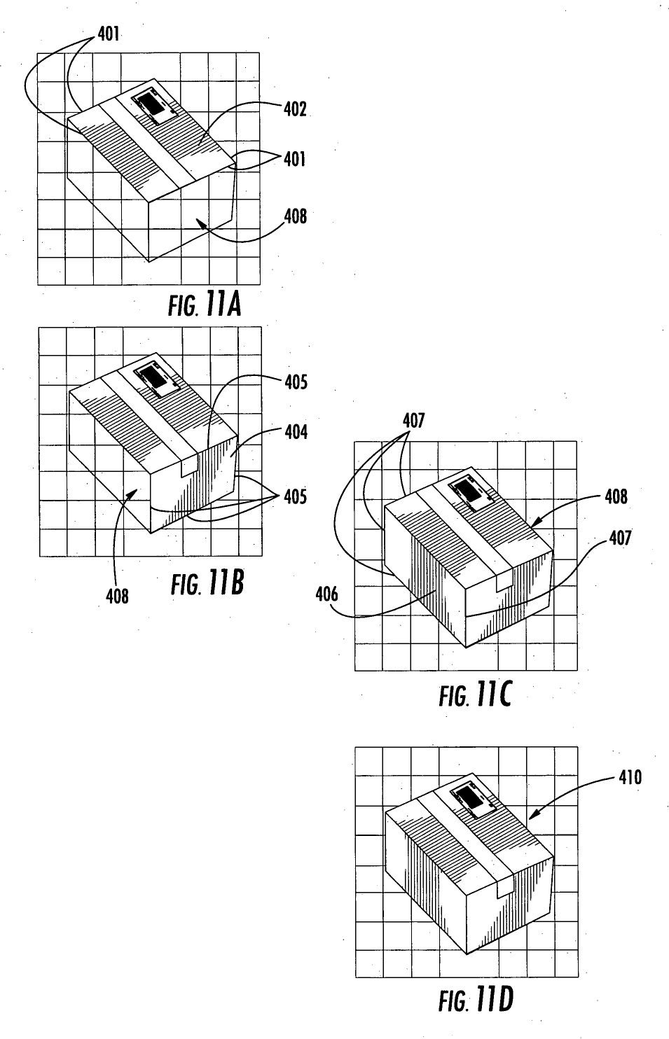

Each two-dimensional image in turn can be matched to the three-dimensional frame in its proper orientation, and in one embodiment matching is achieved using a shifting algorithm. The shifting algorithm, as known in the art, changes the width of two-dimensional image 400, FIG. 10A and matches the height of image 400 as appropriate, shifts image 400 vertically, FIG. 10B and horizontally, FIG. 10C such that it fits within the appropriate frame 401 for that face of the parcel. Thereafter, the two-dimensional image of each parcel face 402, 404, 406, FIGS. 11A-11C which is visible is likewise fitted into its appropriate frame 401, 405, 407 of three-dimensional frame 408, forming the three-dimensional image 410, FIG. 11D. The resulting three-dimensional images can be stored and can be displayed when desired.

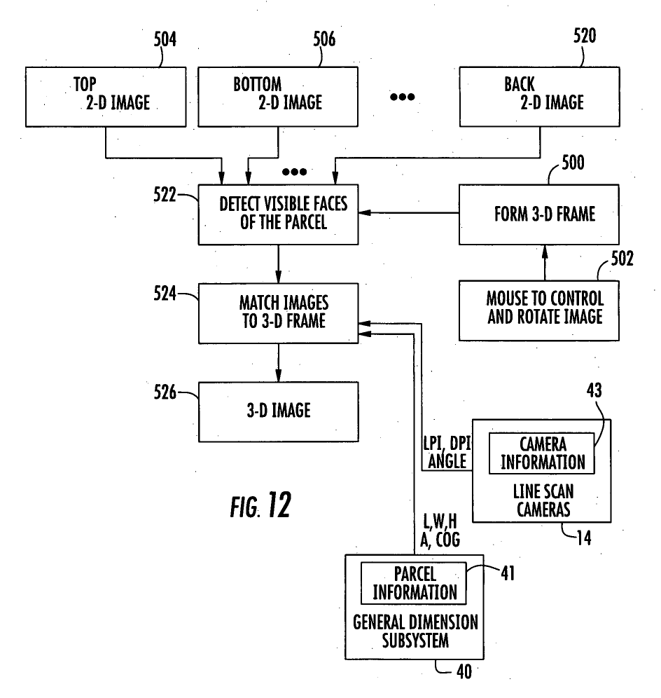

A summary of the operation of three-dimensional image construction module 74, FIG. 3 is shown in flowchart form in FIG. 12. A three-dimensional frame is formed, step 500, which can be controlled and rotated via a mouse, step 502. The two-dimensional image of each visible face i.e. top 504, bottom 506 (front, right and left not shown) and back 520 of a parcel is detected, step 522. Each visible two-dimensional image is matched to its appropriate frame in the overall three-dimensional frame, step 524, forming the three-dimensional parcel image, step 526.

The three-dimensional image may be formed from two or three two-dimensional images fitted to the three-dimensional frame. In some cases, however, an image may not be available for one or more faces of the object, e.g. if there is no bottom camera. In such a case, the parcel bottom face is shown as gray. Thus, in an alternative configuration, the three-dimensional image may be formed using at least one two-dimensional image, and utilizing input from general dimension subsystem 40 (or fine dimensioning subsystem 70), namely, parcel length, width and/or height information, as well as camera information 43 from line scan cameras 14, particularly LPI and DPI information. Two dimensions of the three-dimensional image will be known from the one two-dimensional image. Then, from general dimension subsystem 40 (or from fine dimensioning subsystem 70) the third dimension will be known, and LPI and DPI information from line scan cameras 14 may supply additional information. Therefore, the size and shape of the parcel is known, and the “blank” or gray face is part of the overall constructed three-dimensional image.

The constructed three-dimensional parcel image is rotatable, providing the viewer with multi-angled three-dimensional views and compelling corroboration of the identity and condition of the parcel. Image construction subsystem 46, FIG. 3, includes rotation module or subsystem 66 configured to rotate a displayed three-dimensional image of the parcel to allow any view of the parcel, which in one embodiment is effected via a mouse as discussed above and shown in FIG. 12.

To further enhance the three-dimensional parcel image and provide a more realistic look especially as the parcel is rotated, image construction subsystem 46, FIG. 3 includes brightness adjustment module or subsystem 68. The brightness of the three-dimensional parcel image is adjusted to enhance the view of the parcel, leading to better identification of the parcel and a better view of its condition, and other valuable uses.

Brightness adjustment module or subsystem 68 achieves brightness adjustment for a particular camera image by adjusting the brightness of any one of those individual camera images.

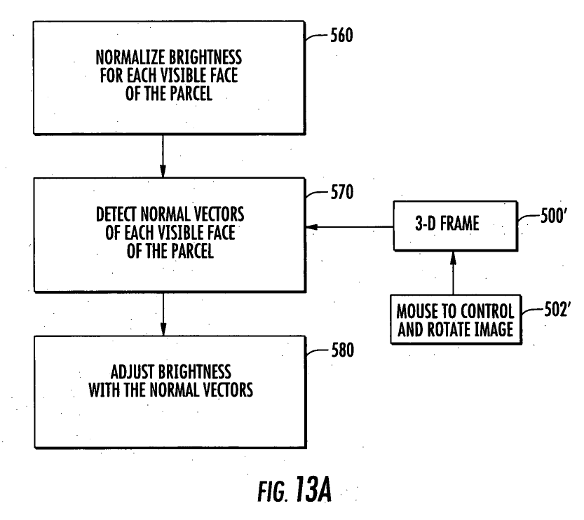

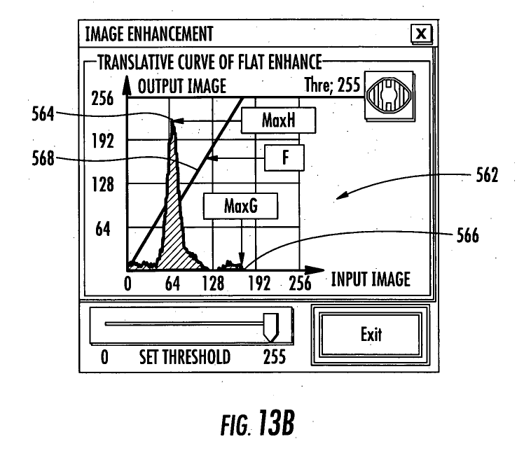

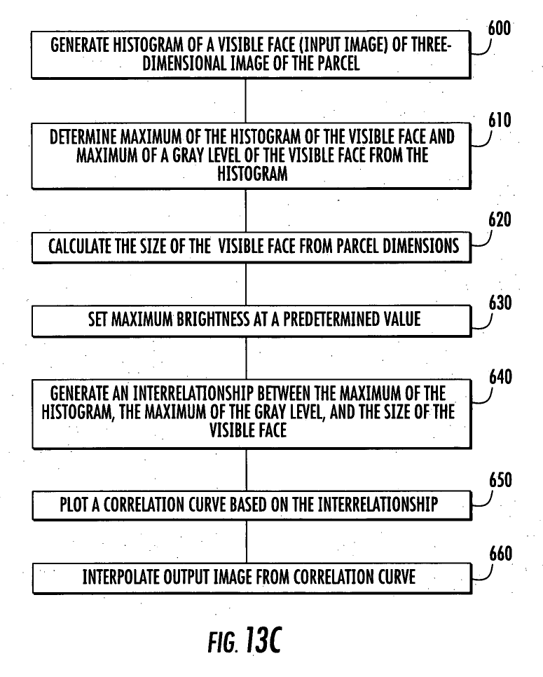

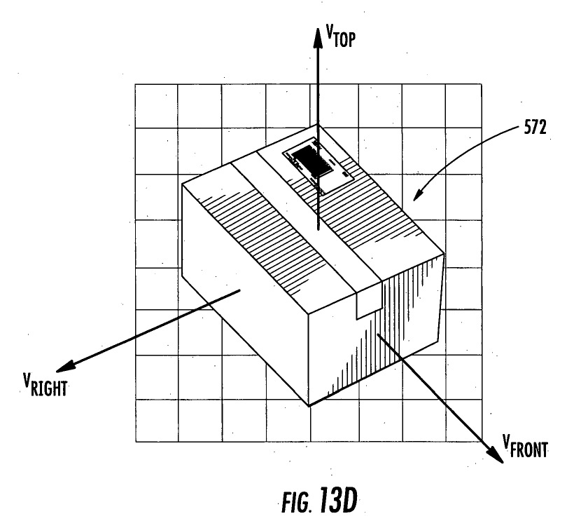

In one embodiment, brightness is normalized while noise and entropy are minimized. The brightness of each visible face of a parcel is normalized and enhanced, step 560, FIG. 13A using a flat enhancement algorithm in accordance with one aspect of the present invention, which is given by the function:

$$F ( g ) = \frac{{\sum }_{g = 0}^{255} ( {Max}_{H} - Histogram [ g ] )}{( {Max}_{H} \cdot {Max}_{G} - ImageSize ) / 255} \qquad ( 1 )$$

where Histogram[g] is the histogram 562, FIG. 13B of the input image, Max_{H}, 564 is the maximum of the histogram of the input image, Max_{G}, 566 is the maximum of the gray level of the input image, and ImageSize is the image size of the input image. In one example, the input image is a visible face of the parcel. The maximum brightness of the input image, e.g. a visible face of the parcel, is set at 255, and from equation (1) a curve is generated, such as curve 568. Thus, for any brightness of any pixel in the inputted image, a pixel with normalized brightness may be determined by interpolating using curve 568. Thus, for any input image (as shown on the x-axis) such as one of the six faces of a parcel, an output image (as shown on the y-axis) with normalized brightness is generated. As noted, normalization is achieved for each visible face of a parcel. A flowchart depicting one example of the normalization of each visible face of the parcel is shown in FIG. 13C, steps 600-660, namely, generate a histogram of a visible face, e.g. the input image, of the three-dimensional image of the parcel, step 600. Using the histogram the maximum of the histogram of the visible face, and the maximum of a gray level of the visible face, are determined, step 610. The size of the visible face is calculated using the parcel dimensions, step 620, and step 630 includes setting the maximum brightness at a predetermined value. Next, an interrelationship between the maximum of the histogram, the maximum of the gray level, and the size of the visible face is generated, step 640. A correlation curve is plotted based on the interrelationship, step 650, and the output image is interpolated using the correlation curve, step 660.

Moreover, as the orientation of an image changes, the brightness may change as well. As noted above, the orientation of the formed three-dimensional frame 500′, FIG. 13A and associated images can be controlled and rotated via a mouse, step 502′. Therefore, in one variation the brightness adjustment module is further configured to adjust the normalized brightness depending on the orientation of the parcel image. The normal vectors for each visible face of the parcel are detected, step 570. In one example as shown in FIG. 13D, the normal vectors for the top, front and right face of parcel 572 are shown as Vₜₒₚ, V_{right}, and V_{front}, respectively. As discussed above, each of the six two-dimensional faces has a z vector values indicative of the two-dimensional image orientation. When the two-dimensional image (of a face) is directly toward the viewer, the z vector value will be 1. If the two-dimensional image is away from the viewer such that it cannot be seen, the z vector value will be less than zero, and the z vector value will be zero if the particular face is perpendicular to the viewer. As shown, the z vector values for the top, right and front of parcel 572 are greater than zero. The z-vector value of each normal vector can therefore be determined. In this example, the brightness for the pixels of each face will be adjusted using the z-vector values for the normal vectors, step 580, FIG. 13A, according to equation (2):
P_{AB}=P_{NB}*V_{Z} (2)
where P_{AB} is the adjusted brightness of pixels of a particular side of the parcel, P_{NB} is the brightness of the normalized brightness of pixels of the particular side of the parcel, and V_{Z} is the z vector value for that particular side of the parcel at any given orientation. Consequently, as the image is rotated, the z vector value changes, and brightness will be adjusted accordingly.

Thus, the brightness adjustment can then be utilized to adjust the brightness of all camera images. Typically, brightness adjust preferably including normalization and brightness adjustment as described, is performed in brightness adjustment module 68, FIG. 3, prior to formulation of the two-dimensional images, but this is not a necessary limitation of the invention. By adjusting the brightness of the two-dimensional images, brightness adjustment module 68 thereby adjusts the brightness of the constructed three-dimensional image.

It may often be desirable to display the dimensions of the parcel along with the three-dimensional image to give a more meaningful indication of the size of the parcel. Fine dimensioning subsystem or module 70, FIG. 3, allows the dimensions of a parcel to be more accurately determined. In one configuration, dimensions, whether general dimensions as determined by general dimension subsystem 40 or the more accurate dimensions, may be displayed for viewing together with the displayed three-dimensional image of the parcel, and this may be achieved in various ways as known in the art. One method and system for obtaining more accurate dimensions of the parcel, which may be utilized in fine dimensioning subsystem 70, is more fully described in the co-pending U.S. patent application filed on even date herewith entitled Parcel Dimensioning Measurement System and Method, by common inventors as those hereof and the same assignee, which is incorporated herein by reference.

File construction module 72, FIG. 3, stores the three-dimensional image of a parcel in a file for later retrieval, and in one example, the three-dimensional parcel image file may also include, associate and/or integrate the parcel's bar code information and/or dimension data in a single file for easy association and retrieval. In one configuration, file construction module 72 will receive bar code information from decoder subsystem 45 and dimension data from general dimension subsystem 40, or fine dimensioning subsystem 70. File construction module 72 creates a file which stores the three-dimensional image, and which can include bar code information and/or dimension data information. In order to save computer storage space, the files or portions of the files created by file construction module 72 may be less than full resolution, and/or image data, bar code, and/or dimension data may be sampled or compressed. In one example, a JPEG of chosen areas such that only every fourth pixel in each direction is stored, with this area being only 1/16^{th} the size of data stored at full resolution. Other compression and/or sampling techniques as known in the art may be used. Also as noted above, all portions of an image except the parcel image may be stripped completely, also saving space. In one embodiment, stripping of the region of interest is accomplished as described above. As with other techniques disclosed herein, these are not necessary limitations of the invention, however, and other sampling techniques and stripping methods may be employed.

It should be understood that although certain subsystems or modules are described herein as part of image construction subsystem 46, the invention is not necessarily so limited, and such modules may be apart from but connected to image construction subsystem 46, and/or part of imaging subsystem 44 as desired for a particular application. Similarly, modules or subsystems described as part of imaging subsystem 44 may be apart from it but connected thereto, and/or part of imaging construction subsystem 46.

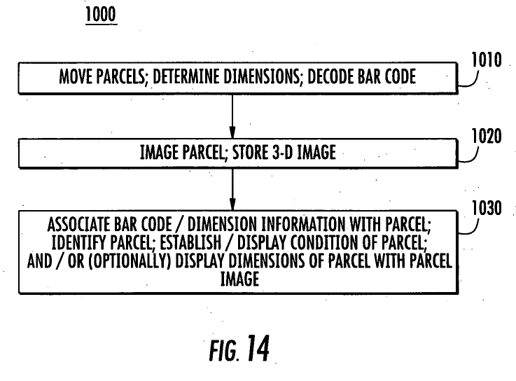

In addition, one aspect of the present invention includes a parcel shipping method which identifies a parcel, establishes its condition and dimensions, and which can detect and/or prevent fraud. Parcel shipping method 1000, FIG. 14, moves parcels through a tunnel at a shipping installation to determine the dimensions of the parcels and to decode bar code information present on the parcels, step 1010. Each parcel is imaged to store at least one displayable three-dimensional image of the parcel, step 1020. Bar code information and/or dimensions of the parcel are associated with the three-dimensional image to identify the parcel, establish the condition of the parcel at the shipping installation, establish the dimensions of the parcel, and/or detect and/or prevent fraud, step 1030. In one preferred embodiment, this parcel shipping method will utilize some combination of the systems and methods described above.

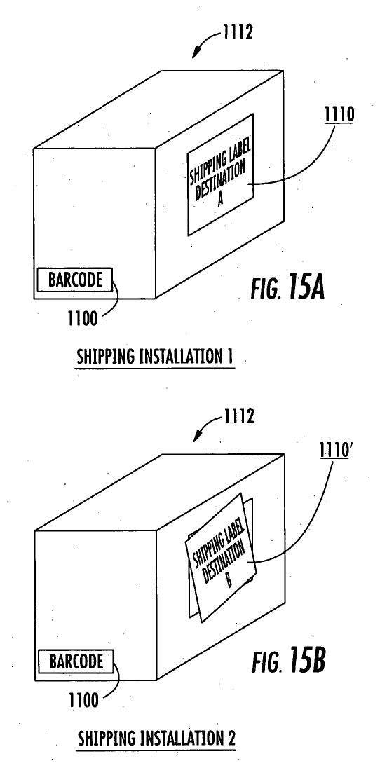

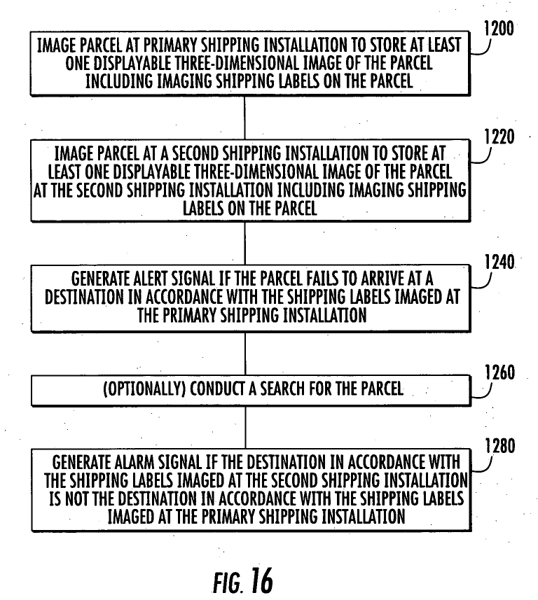

In one example, barcode 1100, FIG. 15A, and shipping label 1110 are imaged and stored either at full resolution, or less than full resolution as discussed above, to include at least the bar code and shipping label for parcel 1112 at a first or primary shipping installation, with parcel 1112 destined for Destination A. Later, at a second shipping installation, FIG. 15B, bar code 1100 and counterfeit shipping label 1110′ of parcel 1112, now slated for a different Destination B, are imaged and stored. In one configuration, if package 1112 fails to arrive at Destination A as designated on shipping label 1110, an alert or alarm signal is generated for parcel 1112. The alert may be generated at a central location of the shipping company, for example. Using stored parcel information such as bar code 1110, a search for parcel 1112 may be conducted, by any interested party such as the shipping company in one example. A search is optional, however. When parcel 1112 is found, such as when it is fraudulently delivered by a shipping company delivery truck driver to Destination B as designated on label 1110′, a reverse alarm or alert signal may be generated, for example to the delivery driver at Destination B, signifying that Destination B is an inappropriate destination. In conjunction with identifying information such as bar code 1110, the three-dimensional image of parcel 1112 can readily show the new shipping label with a different Destination B. A flowchart depicting one example of a parcel shipping method is shown in FIG. 16, steps 1200-1280. The parcel at a primary shipping location is imaged to store at least one displayable three-dimensional image of the parcel, including imaging of shipping labels on the parcel, step 1200. The parcel at a second shipping installation is imaged to store at least one displayable three-dimensional image of the parcel at the second shipping installation including imaging of shipping labels on the parcel, step 1220. If the parcel fails to arrive a destination in accordance with the shipping label(s) imaged at the primary shipping installation, an alert signal is generated, step 1240. Optionally, a search for the parcel may be conducted, step 1260. If the destination of the parcel in accordance with the shipping label(s) imaged at the second shipping installation is not the destination in accordance with the shipping label(s) imaged at the primary shipping installation, an alarm signal is generated, step 1280.

In this way, the actual final destination can be found, and the place where the counterfeit label was attached (shipping installation 2) can be determined. The three-dimensional image provided by the subject invention, in contrast to a simple printout of a listed destination, also can provide powerful evidence of fraud. Accordingly, parcel shipping is improved overall, and fraud can be detected, prevented, and displayed in a most compelling manner.

Accordingly, the parcel imaging systems and methods of the subject invention provide a powerful presentation and impression of the condition of a package or parcel, in order to show lack of damage at a shipping facility, for example. Additionally, the systems and methods of this invention provide a compelling way to identify and dimension such a parcel or package, to show the item that was actually shipped and/or where the item was shipped, to verify correct payment of shipping costs, and better track the item. Thus, the systems and methods of the present invention detect and/or prevent fraud during shipment, and help ensure that parcels arrive at their proper destinations.

Various parts or portions of the systems, subsystems, modules and methods of the subject invention may be embedded in software as may be known to those skilled in the art, and/or may be part of a computer or other processor which may be separate from the remaining systems. These examples are not meant to be limiting, and various parts or portions of the present invention may be implemented in a computer such as a digital computer, and/or incorporated in software module(s) and/or computer programs compatible with and/or embedded in computers or other conventional devices, and the computer's or device's main components may include e.g.: a processor or central processing unit (CPU), at least one input/output (I/O) device (such as a keyboard, a mouse, a compact disk (CD) drive, and the like), a controller, a display device, a storage device capable of reading and/or writing computer readable code, and a memory, all of which are interconnected, e.g., by a communications network or a bus. The systems, subsystems, modules and methods of the present invention can be implemented as a computer and/or software program(s) stored on a computer readable medium in the computer or meter and/or on a computer readable medium such as a tape or compact disk. The systems, subsystems, modules and methods of the present invention can also be implemented in a plurality of computers or devices, with the components residing in close physical proximity or distributed over a large geographic region and connected by a communications network, for example.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant can not be expected to describe certain insubstantial substitutes for any claim element amended.

What is claimed is:

1. A parcel imaging system comprising:
means for transporting parcels;
image sensors oriented to image the parcels; and
an image construction subsystem configured to:
stitch together outputs of the image sensors to produce at least one two-dimensional image of a parcel, and
construct, using the at least one two-dimensional image, at least one displayable three-dimensional image of the parcel.

2. The system of claim 1 in which the image construction subsystem is configured to construct the at least one displayable three-dimensional image of the parcel using at least two two-dimensional images of the parcel.

3. The system of claim 1 further including a general dimension subsystem including parcel dimension information.

4. The system of claim 3 in which the image construction subsystem is configured to construct the at least one displayable three-dimensional image of the parcel using one two-dimensional image of the parcel and at least one parcel dimension.

5. The system of claim 1 in which the at least one three-dimensional image of the parcel does not include any background image.

6. The system of claim 3 further including a background stripper subsystem configured to strip any background image from the at least one two-dimensional image using a combination of image contrast information and parcel dimension information.

7. The system of claim 6 in which the background stripper subsystem is configured to:
determine pixel coordinates of a corner of the parcel in the least one two-dimensional image using the parcel dimension information;
conduct line scans proximate the corner;
calculate an average numerical value of the pixels in each line scan;
detect a significant change in the average numerical value of the pixels of the line scans proximate the pixel coordinates of the corner; and
set the pixel coordinates of the corner to pixel coordinate values where the significant change in the average numerical value of the pixels of the line scans was detected.

8. The system of claim 7 in which the background stripper subsystem is further configured to conduct multi-level detection and set the pixel coordinates of the corner using sub-sampling of the at least one two-dimensional image.

9. The system of claim 7 in which the background stripper subsystem is configured to set the pixel coordinates of four corners of the parcel in the at least one two-dimensional image.

10. The system of claim 7 in which the background stripper subsystem is configured to strip any background image outside of the set pixel coordinates and the dimensions of the two-dimensional image of the parcel.

11. The system of claim 6 in which the background stripper subsystem is configured to:
determine pixel coordinates of a point on the parcel in the least one two-dimensional image using the parcel dimension information;
conduct line scans proximate said point;
calculate an average numerical value of the pixels in each line scan;
detect a significant change in the average numerical value of the pixels of the line scans proximate the pixel coordinates of said point; and
set the pixel coordinates of said point to pixel coordinate values where the significant change in the average numerical value of the pixels of the line scans was detected.

12. The system of claim 11 in which the parcel dimension information is general parcel dimension information.

13. The system of claim 12 in which the background stripper subsystem is configured to locate a plurality of points on the two-dimensional image of the parcel.

14. The system of claim 13 in which the background stripper subsystem is further configured to create a mapping of said points in the two-dimensional image, and using said mapping, formulate at least one line representing at least one edge of the parcel in the two-dimensional image.

15. The system of claim 14 in which the background stripper subsystem is further configured to formulate lines representing each edge of the parcel in the two-dimensional image.

16. The system of claim 10 in which the image construction subsystem is configured to construct the at least one displayable three-dimensional image from stripped two-dimensional images.

17. The system of claim 11 in which the image construction subsystem is configured to construct the at least one displayable three-dimensional image by fitting the stripped two-dimensional images into a three-dimensional frame.

18. The system of claim 1 in which the two-dimensional images are less than full resolution.

19. The system of claim 18 in which the image construction subsystem is configured to sample each two dimensional image.

20. The system of claim 19 in which the image construction subsystem is configured to compress each two-dimensional image.

21. The system of claim 1 in which the image construction subsystem is configured to display any view of the at least one displayable three-dimensional image of the parcel.

22. The system of claim 1 further including a rotation module configured to rotate the at least one displayable three-dimensional image of the parcel.

23. The system of claim 3 further including a brightness adjustment module configured to adjust the brightness of the at least one three-dimensional image of the parcel.

24. The system of claim 23 in which the brightness adjustment module is configured to:
normalize the brightness of each visible face of the at least one three-dimensional image of the parcel; and
adjust the normalized brightness depending on the orientation of the parcel.

25. The system of claim 24 in which the brightness adjustment module is configured to normalize the brightness of each visible face of the at least one three-dimensional image of the parcel by:
generating a histogram of a visible face of the at least one three-dimensional image of the parcel;
determining from the histogram the maximum of the histogram of the visible face;
determining the maximum of a gray level of the visible face using the histogram;
calculating the size of the visible face using parcel dimension information;
setting maximum brightness of the visible face at a predetermined value;
generating an interrelationship between the maximum of the histogram, the maximum of the gray level, and the size of the visible face;
plotting a correlation curve based on the interrelationship; and
interpolating a normalized output image using the correlation curve.

26. The system of claim 25 in which the brightness adjustment module is configured to adjust the normalized brightness by:
detecting a normal vector for a visible face of the at least one three-dimensional image of the parcel;
determining a z-vector value for the normal vector detected; and
multiplying the z-vector value by the normalized brightness of the visible face.

27. The system of claim 1 further including a dimensioning module configured to display parcel dimensions with the at least one three-dimensional image of the parcel.

28. The system of claim 1 in which the image construction subsystem is configured to store the three-dimensional image of the parcel in a file.

29. The system of claim 23 in which said file further includes data concerning said parcel.

30. The system of claim 29 in which said data includes bar code data.

31. The system of claim 30 in which said data includes parcel dimension data.

32. The system of claim 1 in which the image sensors are line scan cameras.

33. A parcel imaging method comprising:
transporting parcels;
imaging the parcels with image sensors;
stitching together outputs of the image sensors to produce at least one two-dimensional image of a parcel; and
constructing, using the at least one two-dimensional image, at least one displayable three-dimensional image of the parcel.

34. The method of claim 33 in which constructing the at least one displayable three-dimensional image of the parcel includes using at least two two-dimensional images of the parcel.

35. The method of claim 33 further including a general dimension subsystem including parcel dimension information.

36. The method of claim 35 in which constructing the at least one displayable three-dimensional image of the parcel includes using one two-dimensional image of the parcel and at least one parcel dimension.

37. The method of claim 33 in which the at least one three-dimensional image of the parcel does not include any background image.

38. The method of claim 37 in which the background image is stripped from the two-dimensional image using a combination of image contrast information and parcel dimension information.

39. The method of claim 38 in which the background image is stripped from the two-dimensional image by the steps comprising:
determining pixel coordinates of a corner of the parcel in the least one two-dimensional image using the parcel dimension information;
conducting line scans proximate the corner;
calculating an average numerical value of the pixels in each line scan;
detecting a significant change in the average numerical value of the pixels of the line scans proximate the pixel coordinates of the corner; and
setting the pixel coordinates of the corner to pixel coordinate values where the significant change in the average numerical value of the pixels of the line scans was detected.

40. The method of claim 39 including conducting multi-level detection and setting the pixel coordinates of the corner using sub-sampling of the at least one two-dimensional image.

41. The method of claim 39 including setting the pixel coordinates of four corners of the parcel in the at least one two-dimensional image.

42. The method of claim 39 including stripping any background image outside of the set pixel coordinates and the dimensions of the two-dimensional image of the parcel.

43. The method of claim 38 in which the background image is stripped from the two-dimensional image by the steps comprising:
determining pixel coordinates of a point on the parcel in the least one two-dimensional image using the parcel dimension information;
conducting line scans proximate said point;
calculating an average numerical value of the pixels in each line scan;
detecting a significant change in the average numerical value of the pixels of the line scans proximate the pixel coordinates of said point; and
setting the pixel coordinates of said point to pixel coordinate values where the significant change in the average numerical value of the pixels of the line scans was detected.

44. The method of claim 43 in which the parcel dimension information is general parcel dimension information.

45. The method of claim 44 including locating a plurality of points on the two-dimensional image of the parcel.

46. The method of claim 45 further including creating a mapping of said points and from said mapping formulating at least one line representing at least one edge of the parcel in the two-dimensional image.

47. The method of claim 46 further including formulating lines representing each edge of the parcel in the two-dimensional image.

48. The method of claim 42 including constructing the at least one displayable three-dimensional image from stripped two-dimensional images.

49. The method of claim 48 including constructing the at least one displayable three-dimensional image by fitting the stripped two-dimensional images into a three-dimensional frame.

50. The method of claim 33 in which the two-dimensional images are less than full resolution.

51. The method of claim 50 in which each two-dimensional image is sampled.

52. The method of claim 50 further including compressing each two-dimensional image.

53. The method of claim 33 further including displaying any view of the at least one three-dimensional image of the parcel.

54. The method of claim 33 further including rotating the at least one displayable three-dimensional image of the parcel.

55. The method of claim 33 further including adjusting the brightness of the at least three-dimensional image of the parcel.

56. The method of claim 55 in which adjusting the brightness includes the steps comprising:
normalizing the brightness of each visible face of the at least one three-dimensional image of the parcel; and
adjusting the normalized brightness depending on the orientation of the parcel.

57. The method of claim 56 in which normalizing the brightness includes the steps comprising:
generating a histogram of a visible face of the at least one three-dimensional image of the parcel;
determining from the histogram the maximum of the histogram of the visible face;
determining the maximum of a gray level of the visible face using the histogram;
calculating the size of the visible face using parcel dimension information;
setting maximum brightness of the visible face at a predetermined value;
generating an interrelationship between the maximum of the histogram, the maximum of the gray level, and the size of the visible face;
plotting a correlation curve based on the interrelationship; and
interpolating a normalized output image using the correlation curve.

58. The method of claim 57 in which adjusting the normalized brightness includes the steps comprising:
detecting a normal vector for a visible face of the at least one three-dimensional image of the parcel;
determining a z-vector value for the normal vector detected; and
multiplying the z-vector value by the normalized brightness of the visible face.

59. The method of claim 33 further including displaying parcel dimensions with the at least one three-dimensional image of the parcel.

60. The method of claim 33 further including storing the at least one three-dimensional image of the parcel in a file.

61. The method of claim 60 in which said file further includes data concerning said parcel.

62. The method of claim 61 in which said data includes bar code data.

63. The method of claim 61 in which said data includes parcel dimension data.

64. The method of claim 33 in which the image sensors are line scan cameras.

65. A parcel shipping method comprising:
moving parcels through a tunnel at a primary shipping installation to determine the dimensions of the parcels and to decode bar code information present on the parcels;
imaging each parcel to store at least one displayable three-dimensional image of the parcel; and
associating bar code information and/or dimensions of the parcel with the three-dimensional image to identify the parcel, establish the condition of the parcel at the shipping installation, establish the dimensions of the parcel, and/or to detect and/or prevent fraud.

66. The method of claim 65 in which imaging each parcel to store at least one displayable three-dimensional image of the parcel includes imaging shipping labels on the parcel.

67. The method of claim 66 further including imaging each parcel at a second shipping installation to store at least one displayable three-dimensional image of the parcel at the second shipping installation.

68. The method of claim 67 in which imaging each parcel at a second installation includes imaging shipping labels on the parcel.

69. The method of claim 68 further including generating an alert signal if the parcel fails to arrive at a destination in accordance with a shipping label imaged at the primary shipping installation.

70. The method of claim 69 further including conducting a search for the parcel.

71. The method of claim 69 further including generating an alarm signal if the destination in accordance with the shipping label imaged at the second shipping installation is not the destination in accordance with a shipping label imaged at the primary shipping installation.

72. The method of claim 65 in which the tunnel includes line scan cameras oriented to image the parcel.

73. The method of claim 72 in which imaging each parcel includes:
stitching together outputs of the line scan cameras to produce at least one two-dimensional image of a parcel, and
constructing, using the at least one two-dimensional images, at least one displayable three-dimensional image of the parcel.
